(19) United States
(12) Patent Application Publication
(10) Pub. No.: US 2013/0026726 A1
(43) Pub. Date: Jan. 31, 2013

(54) Customizable Pack and System and Method of Constructing and Using Same

(71) Applicant: Christina L. Thomas, Hollister, CA (US)

(72) Inventor: Christina L. Thomas, Hollister, CA (US)

(21) Appl. No.: 13/194,939

(22) Filed: Jul. 30, 2011

(51) Int. Cl. B62B 1/00; A45F 3/04; A45F 5/00

(52) U.S. Cl. 280/43.1; 224/191; 224/627

(57) ABSTRACT

The present invention is generally directed to a pack, such as a backpack or daypack, that is customizable in size, functionality and features, and appearance. The pack has two physically separate portions, the front of the pack and the back of the pack, that are releasably connected together to form the pack and an accessible space therein. An optional middle portion or expandable panel can be added between the front and back portions to further expand the size of the accessible space. The pack can be customized through the selection of material and design of the material, shoulder straps, a waist belt, a pull handle or cart and wheels, and detachable pockets of different sizes and shapes. The pack can also be personalized through the addition of various design elements. A pack system is also provided that allows complete customization of a pack and its features.

### BACKGROUND OF THE INVENTION

1. Field of the Invention

The invention in its various embodiments generally relates to packs, such as daypacks, backpacks, and the like. More specifically, the invention in its various embodiments relates to packs that are customizable by size, functionality and features, and appearance.

2. Description of Related Art

Packs, such as daypack, backpacks, and the like are used for various purposes. For example, packs are used by students to carry books and other articles, by travelers to carry personal items, by hikers to carry food and other items, and by athletes to carry sports gear, as well as by the ordinary person for carrying items that may be needed throughout the day. Accordingly, packs are used by many different people for many different purposes.

An individual that uses a pack may appreciate the ability to customize the pack for the specific use intended by that individual. For example, if the intended use is to carry a large item, it would be desirable to be able to increase the size or volume of the pack. If the intended use is to carry an item that needs to be easily accessible, such as a cell phone, it would be desirable to add a pocket or outside compartment to the pack, particularly a pocket that is designed for a specific purpose, in this case, to hold a cell phone. In addition, an individual may appreciate the ability to customize the appearance of the pack, for example, by selecting different fabrics or materials from which the pack is made and by adding pockets or compartments to the outside of the pack. Consequently, there exists a need in the art for a pack and a pack system that provides a pack that can be customized by size, functionality and features, and appearance.

### BRIEF SUMMARY OF THE INVENTION

The present invention is generally directed to a pack, such as a backpack or daypack, that is customizable in size, functionality and features, and appearance. The main pack is made from two physically separate portions, the front of the pack and the back of the pack, that are releasably connected together to form the pack and an accessible space therein. The shape of the pack and the size of the accessible space can be altered depending upon the shape and size of the front and back portions. In addition, a middle portion or expandable panel can be added between the front and back portions to further expand the size of the accessible space. The pack can be customized through the selection of material and design of the material, as well as with shoulder straps, a waist belt, or a pull handle or pull cart and wheels. The pack can be further customized through the use of detachable pockets of different sizes and shapes that can also be specifically sized and designed for a particular purpose. The pack can also be personalized through the addition of various design elements. Once configured, the pack can be easily re-configured by changing various features. For example, additional pockets can be added or existing pockets can be removed, pockets can be switched to other pockets, the expandable panel can be added or removed, shoulder straps can be switched with other straps, and a pull handle or pull cart can be added or removed. Accordingly, the pack can be configured for use and then subsequently configured differently through the removal and addition of these and other various features. Each of these aspects of the pack is described below in further detail.

In one embodiment, the pack comprises a front portion comprising a front inner surface of a pack and a front connection perimeter; and a back portion comprising a back inner surface of the pack and a back connection perimeter, wherein the front portion and the back portion are configured to be connected by a releasable connection disposed along a connection perimeter formed by alignment of the front connection perimeter and the back connection perimeter and to define an accessible enclosed space of the pack that extends from the front inner surface to the back inner surface.

In another embodiment, the pack comprises a front portion comprising a front surface of a pack and a front connector portion disposed about a perimeter of said front portion; and a back portion comprising a back surface of the pack and a back connector portion disposed about a perimeter of the back portion, wherein the front portion and the back portion are configured to be connected by a releasable connection formed between the front connector portion and the back connector portion to define an accessible enclosed space of said pack that extends from the front surface to the back surface.

In another embodiment, a system for a pack is provided that comprises a front portion selected from a plurality of front portions, each comprising a front connector portion and constructed from a front material selected from a plurality of materials; a back portion selected from a plurality of back portions, each comprising a back connector portion compatible with the front connector portion to allow a releasable connection to be formed by connecting the front connector portion and the back connector portion, and each constructed from a back material selected from the plurality of materials; and at least one pocket configured to be attached to either the front portion or the back portion selected from a plurality of pockets each configured for attachment to either the front portion or the back portion.

### BRIEF DESCRIPTION OF THE SEVERAL VIEWS OF THE DRAWINGS

FIG. 1 is a perspective view of a pack made according to an embodiment of the invention;

FIG. 2 is a side view of the pack of FIG. 1 made according to an embodiment of the invention;

FIG. 3 is a top view of the pack of FIG. 1 made according to an embodiment of the invention;

FIG. 4 is a bottom view of the pack of FIG. 1 made according to an embodiment of the invention;

FIG. 5 is a perspective view of the pack of FIG. 1 made according to an embodiment of the invention;

FIG. 6 is a rear view of the pack of FIG. 1 made according to an embodiment of the invention;

FIG. 7 is a rear view of the pack of FIG. 1 made according to another embodiment of the invention;

FIG. 7A is a side view of a pull cart according to one embodiment of the invention.

FIG. 7B is a perspective view of the pull cart of FIG. 7A;

FIG. 8 is an exploded view of two pockets attached to a pack made according to an embodiment of the invention;

FIG. 8A is an exploded view of a single pocket attached to a pack made according to an embodiment of the invention;

FIG. 8B is another pocket attached to a pack made according to an embodiment of the invention;

FIG. 8C is an exploded view of the pockets illustrated in FIG. 8B;

FIG. 9 illustrates a side pocket attached to a side of a pack according to an embodiment of the invention;

FIG. 10 is an exploded side view of a pack and a middle portion according to an embodiment of the invention;

FIG. 11 is a perspective view of a releasable connection between a front portion and a back portion of a pack according to an embodiment of the invention;

FIG. 12 is a perspective view of another releasable connection between a front portion and a back portion of a pack according to an embodiment of the invention; and

FIG. 13 is a perspective view of another pack according to an embodiment of the invention.

### DETAILED DESCRIPTION OF THE INVENTION

Various embodiments of the invention are described below in conjunction with the Figures. However, this description should not be viewed as limiting the scope of the present invention. Rather, it should be considered as exemplary of various embodiments that fall within the scope of the present invention as defined by the claims. Further, it should also be appreciated that references to “the invention” or “the present invention” should not be construed as meaning that the description is directed to only one embodiment or that every embodiment must contain a given feature described in connection with another embodiment or described in connection with the use of such phrases. In fact, various embodiments with common and differing features are described herein.

The present invention is generally directed to a pack, such as a backpack or daypack, that is customizable in size, functionality and features, and appearance. The main pack is made from two physically separate portions, the front of the pack and the back of the pack, that are releasably connected together to form the pack and an accessible space therein. The shape of the pack and the size of the accessible space can be altered depending upon the shape and size of the front and back portions. In addition, a middle portion or expandable panel can be added between the front and back portions to further expand the size of the accessible space. The pack can be customized through the selection of material and design of the material, as well as with shoulder straps, a waist belt, or a pull handle or pull cart and wheels. The pack can be further customized through the use of detachable pockets of different sizes and shapes that can also be specifically sized and designed for a particular purpose. The pack can also be personalized through the addition of various design elements. Once configured, the pack can be easily re-configured by changing various features. For example, additional pockets can be added or existing pockets can be removed, pockets can be switched to other pockets, the expandable panel can be added or removed, shoulder straps can be switched with other straps, and a pull handle or pull cart can be added or removed. Accordingly, the pack can be configured for use and then subsequently configured differently through the removal and addition of these and other various features. Each of these aspects of the pack is described below in further detail.

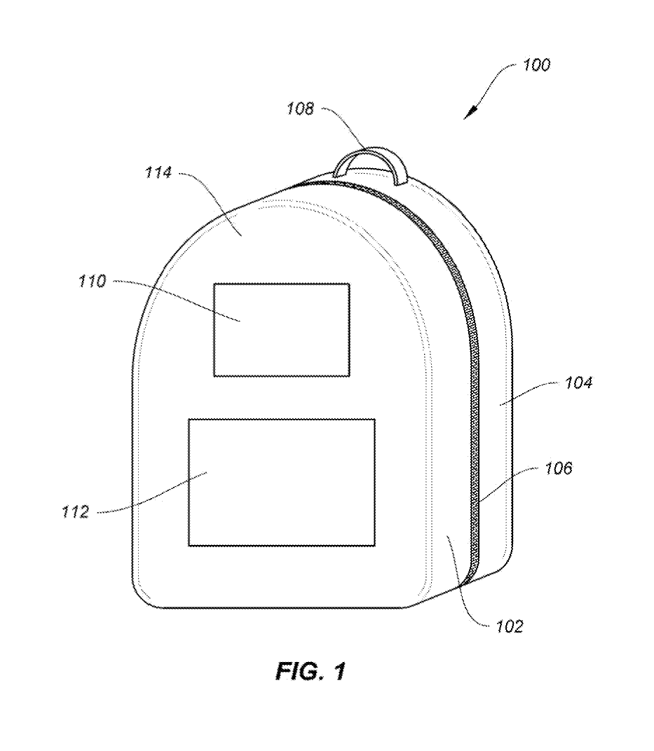

FIG. 1 is a perspective view of a pack made according to an embodiment of the invention. Pack 100 comprises a front portion 102 and a back portion 104. The front portion 102 and the back portion 104 are connected to each other by a releasable connection 106. The releasable connection 106 extends around the entire pack 100 and, therefore, allows the front portion 102 and the back portion 104 to be physically separated from each other and connected to each other. In other words, the front portion 102 and the back portion 104 are physically separate components of the pack 100 that when connected to each other by the releasable connection 106 form the body of the pack 100 and define an accessible space within the pack 100. In some embodiments, this accessible space is the main compartment of a pack.

Pack 100 may also comprise an optional handle 108 attached to either the top of the front portion 102 or the top of the back portion 104 (as shown in FIG. 1). It should be appreciated that additional handles may also be added to either portion of the pack 100 and that any of the handles can be placed wherever desired on the pack 100. Pack 100 may also comprise optional pockets 110, 112 attached to the outer surface 114 of the front portion 102. It should be appreciated that other additional pockets may be added to any outer surface of the pack 100, as described further below. In addition, it should be appreciated that pockets may also be added to any of the interior surfaces of the pack 100, as described further below.

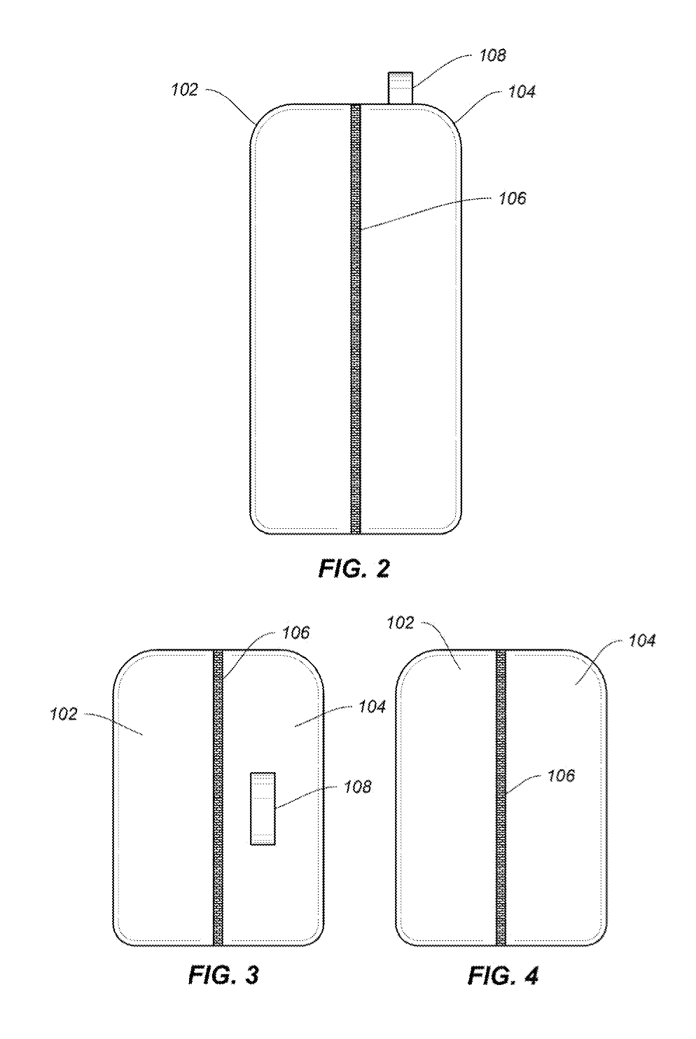

FIG. 2 is a side view of the pack of FIG. 1 made according to an embodiment of the invention. As shown, the releasable connection 106 extends along the entire side of the pack 100. It should be appreciated that the releasable connection 106 also extends along the entire opposite side of the pack 100 (not shown) in a similar manner.

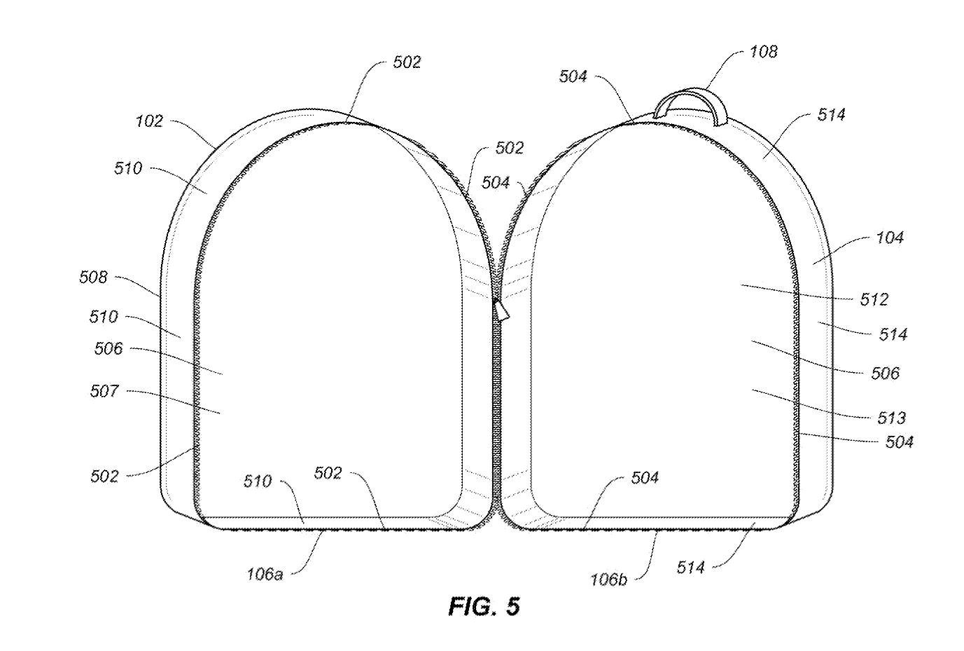

FIG. 3 is a top view of the pack of FIG. 1 made according to an embodiment of the invention. As shown, the releasable connection 106 extends along the entire top of the pack 100.

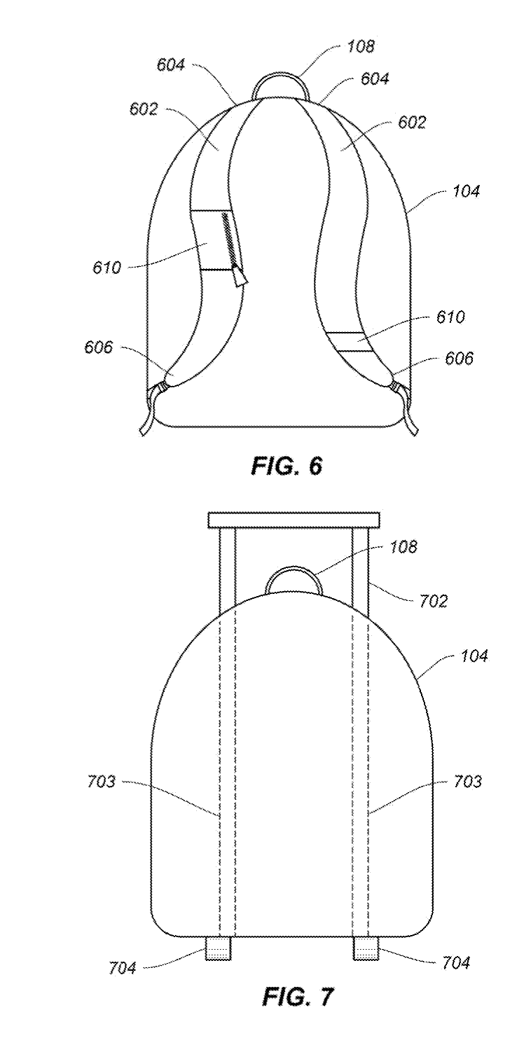

FIG. 4 is a bottom view of the pack of FIG. 1 made according to an embodiment of the invention. As shown, the releasable connection 106 extends along the entire bottom of the pack 100. Notably, when the pack 100 is positioned so that it is resting on its bottom surface, the front portion 102 and the back portion 104 form left and right side portions of the pack 100, as opposed to top and bottom portions.

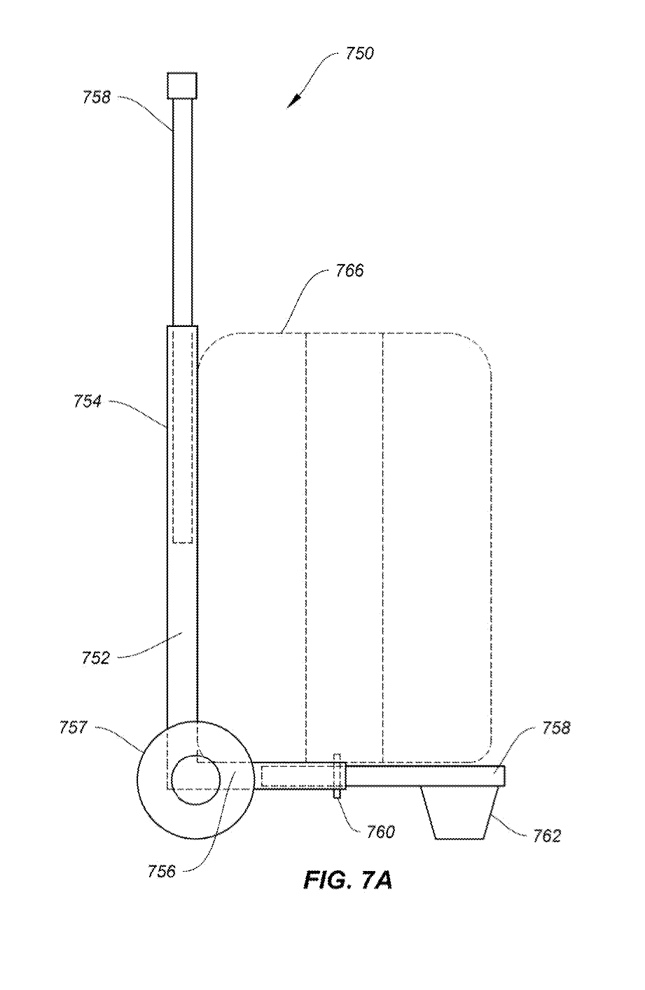

FIG. 5 is a perspective view of the pack of FIG. 1 made according to an embodiment of the invention. In this view, the pack 100 is opened along a portion of the releasable connection 106, which allows the two portions 102, 104 of the pack 100 to be connected to each other and allows the two portions 102, 104 to be completely separated from each other.

The releasable connection 106 may be made using any connectors known in the art that can be used to connect the two portions 102, 104 of the pack 100 together to form the releasable connection 106. In one embodiment, the releasable connection may include connectors that have separate cooperating connector portions that are configured to mate to form a connection and that are configured to be separated from each after mating, thereby forming a releasable connection. In such cases, one connector portion may be placed on one portion of the pack (e.g., the front portion 102), and a corresponding connector portion may be placed on the other portion of the pack (e.g., the back portion 104) such that the two connector portions can be cooperatively mated to form a complete connection. The two connector portions are also configured such that the connection can be reversed and the connector portions separated from each other. Examples of cooperating connector portions that can be used include, without limitation, zippers; snaps; buttons; eyelets on one portion of the pack and a corresponding series of connectors on the other portion, such as hooks, clasps, safety pins, and laces; and hooks and loops (e.g., VELCRO); buckles, snap hooks, swivel hooks, sliders, and webbing.

FIG. 5 illustrates the use of a zipper as one example of cooperating connector portions used to form the releaseable connection 106. As shown in FIG. 5, one connector portion 106a, or one half of the zipper, is disposed along a perimeter 502 of the front portion 102, specifically at the outermost edge of the front portion 102, and another corresponding connector portion 106b, or the other half of the zipper, is disposed along a perimeter 504 of the back portion 104, specifically at the outermost edge of the back portion 104. In other words, the tape of fabric holding one-half of the zipper teeth is disposed along the front connection perimeter 502, and the tape of the fabric holding the cooperating second-half of the zipper teeth is disposed along the back connection perimeter 504. The two connector portions 106a, 106b can then be mated or connected together, and separated from each other, to form the complete releasable connection 106 that holds the front portion 102 together with the back portion 104 and that allows the front portion 102 and the back portion 104 to be separated from each other.

It should be appreciated that the corresponding connector portions 106a, 106b may be placed in any location on the front portion 102 and the back portion 104, respectively. The specific location where one connector portion 106a is attached to the front portion 102 is referred to as the “front connection perimeter,” or that location on the front portion 102 that is intended to be connected to the back portion 104. Similarly, the specific location where the other connector portion 106b is attached to the back portion 104 is referred to as the “back connection perimeter,” or that location on the back portion 104 that is intended to be connected to the front portion 102. In forming the releasable connection 106, the front connection perimeter 502 is aligned with the back connection perimeter 504 to allow the two connector portions 106a, 106b to mate, thereby forming the pack 100 and defining the accessible space 506 in the pack 100. The location where the front connection perimeter and the back connection perimeter are aligned and connected (i.e., the location of the releasable connection for the pack) is referred to as the “connection perimeter.”

The zipper is also an example of a releasable connection that is continuous in that the front portion is connected to the back portion all along the connection perimeter. A series of snaps located about the connection perimeter would not be continuous, as the snaps are discrete and separate from one another and leave locations along the connection perimeter where the front portion is not actually physically connected to the back portion. Hooks and loops could be continuous if the backing for the hooks and loops is placed about the entire connection perimeter (i.e., a backing of hooks placed about the entire front connection perimeter and a backing of loops placed about the entire back connection perimeter or vice versa, such that when connected there are no sections along the front connection perimeter that are not connected to the back connection perimeter and vice versa). Hooks and loops could also be used in a non-continuous manner by only using discrete sections of hooks and loops along the connection perimeter. For example, multiple short lengths of backing for hooks could be placed at certain locations along the front connection perimeter and corresponding lengths of backing for loops could be placed along the back connection perimeter. In this case, once the hooks and loops are connected, there would be certain lengths along the connection perimeter where the front portion and the back portion do not actually connect to each other making the connection non-continous.

In another embodiment (not shown), the releasable connection 106 may include a plurality of connectors disposed only the front portion 102 that connect to the back portion 104, or vice versa. For example, hooks, pins (such as safety pins) or clamps attached to the front portion 102 can be used to grab and hold the back portion 104 together with the front portion 102, even though there is no specific corresponding connector portion disposed on the back portion 104 or vice versa. In this case, the connectors are simply attaching to the fabric or material used to construct the back portion 104. Alternatively, such connectors may be disposed on both the front portion 102 and the back portion 104 to grab and hold the corresponding opposition portion. However, in this case too, it should be appreciated that there is no corresponding connector portion on the opposite portion of the pack with which the connector on the other portion of the pack cooperates. In addition, the use of these types of connectors would not provide a continuous releasable connection.

The sufficiency with which the releasable connection 106 connects the two portions 102, 104 may vary depending, in part, upon the intended use of the pack 100. For example, if the pack 106 will be used to carry small or tiny items, then the releasable connection 106 should provide a sufficient seal between the two portions 102, 104 of the pack 100 to prevent such items from falling out of the pack 100. In this case, the releasable connection 106 may need to be a continuous connection as shown in FIG. 5. Alternatively, if only large items will be carried in the pack 100 or if a certain amount of ventilation is desired in the pack 100, then the releasable connection 106 may not need to be continuous and may comprise multiple, discrete connection points or a non-continuous connection. In this case, the openings between the front portion and the back portion where a connection is not made may be small enough to prevent larger items from falling out of the pack 100 or may be sufficiently sized to allow air to pass through these openings.

The shape of the front portion 102 and the back portion 104 may be any desired shape. Referring to FIG. 5, the front portion 102 comprises a front side 508, which has a front inner surface 507 and an opposite front outer surface (not shown in FIG. 5), and a front panel 510 that extends from the front side 508 and forms at least part of the sides, top, and bottom of the pack 100. Similarly, the back portion 104 comprises a back side 512, which has a back inner surface 513 and an opposite back outer surface (not shown in FIG. 5), and a back panel 514 that extend from the back side 512 and forms at least part of the sides, top, and bottom of the pack 100. It should be appreciated that the panels 510, 514 may be separate pieces connected together, such as side panels, a top panel, and a bottom panel, or a single integrated piece attached to the front or back side 508, 512. In either case, the amount of accessible space 506 is defined by the size and shape of the front portion 102 and the back portion 104. As shown, the accessible space 506 extends from the front inner surface 507 of the front side 508 to the back inner surface 513 of the back side 512.

It should be appreciated that the panels 510, 514 may be any width or depth as measured from the outer edge of the panels 510, 514 to the point where they are attached to the front side 508 and the back side 512, respectively. Accordingly, the depth provided by the panels 510, 514 from their outside edges to the front side 508 and the back side 512, respectively, can be altered. For example, the panel 510 on the front portion 102 may have a different width or depth than the panel 514 on the back portion 104. In this case, once the front portion 102 and the back portion 104 are connected, the majority of the accessible space 506 will have been provided by or defined by the total width or depths of the combined front and back panels 501, 514. It should be appreciated that the panel 510 on the front portion 102 may also be larger or have a larger width or depth than the panel 514 on the back portion 104 or vice versa. In this case, once the front portion and the back portion are connected, the majority of the accessible space 506 will have been provided by or defined by the panel 510 on the back portion 102 or vice versa. In one embodiment, the front portion 102 may not have any panel at all. In this case, the front portion 102 may simply include a flat front side 508 without any panel or depth, and the front connection perimeter would be located simply about the perimeter of the flat front side 508. Accordingly, it should be appreciated that the amount of accessible space 506 defined by the front portion 102 and the back portion 104 can also be altered or tailored by simply adjusting the width or depth of the panels 510, 514.

Also, with reference to FIGS. 2-4, it should be appreciated that the location of the releasable connection 106 or the connection perimeter will vary depending upon the depth or width provided by the panels on the front and back portions 102, 104. In other words, the releasable connection 106 shown in FIG. 2 may be closer to the left or right side of the pack 100 as shown depending upon the width or depth of the panels 510, 514. In any case, with respect to FIGS. 1-5, it should be appreciated that the releasable connection 106 is positioned in a plane that is parallel to the front side 508 and the back side 512. However, this orientation of the releasable connection to the front and back sides can be varied such that the releasable connection is not in a parallel plane to the front and back side and may not even be in a single plane itself.

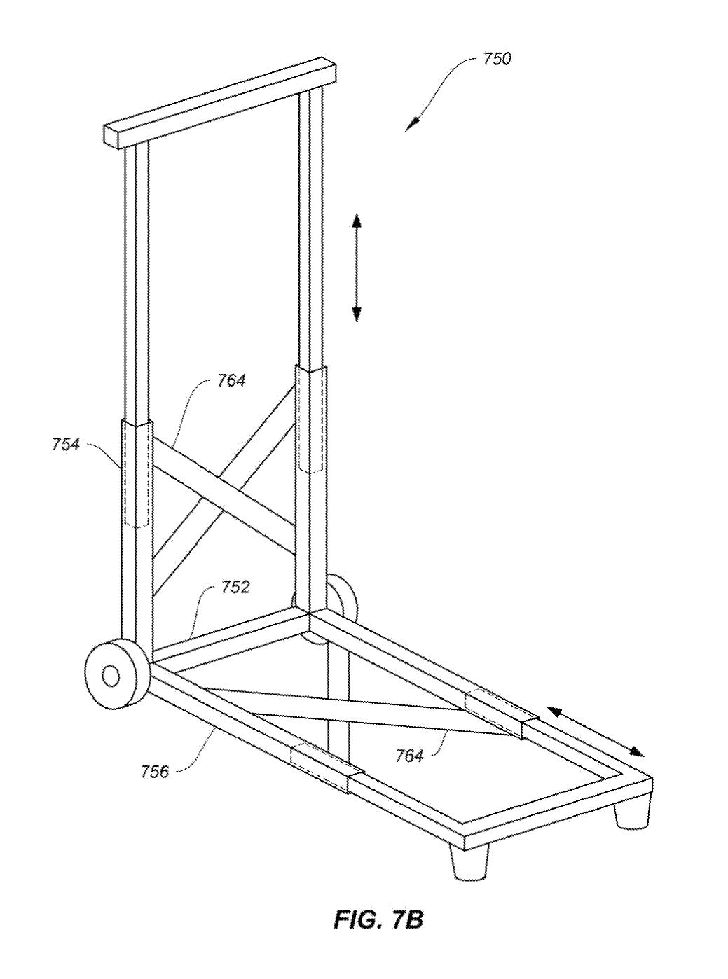

FIG. 6 is a rear view of the pack of FIG. 1 made according to an embodiment of the invention. In this embodiment, the back portion 104 includes two shoulder straps 602 that can be used to carry the pack 100. The tops 604 of the shoulder straps 602 are attached near the top of the back portion 104 in any manner known in the art. The bottoms 606 of the shoulder straps 602 are attached near the bottom of the back portion 104, which may include attachment at the bottom edge, the corner, or on the side of the back portion 104 or the panel. It should be appreciated that the bottoms 606 of the shoulder straps 602 may be attached to the back portion 104 in any manner known in the art. In some embodiments, the bottoms 606 of the shoulder straps 602 are attached using an adjustable strap at each point of attachment that allows a user to adjust the length of the shoulder straps 602. In other embodiments, the shoulder straps themselves may be adjustable to allow for their length to be adjusted. The shoulder straps 602 may also be padded and may be contoured to accommodate a more comfortable and ergonomic fit. In addition, the shoulder straps 602 may be used in conjunction with a waist belt (not shown) that may also be attached to the back portion 104 in a manner similar to the shoulder straps 602. It should also be appreciated that a single shoulder strap may be used, such as a sling-type pack.

The shoulder straps 602 may include one or more pockets 610 located on the straps themselves. The pockets 610 may be detachable (as described further below) or permanently mounted. The pockets 610 can be configured to accommodate a cell phone or other electronic device or can be designed simply for generic storage. Accordingly, the pockets 610 may be an open sleeve or may be capable of being closed through use of a zipper, snaps, hooks and loops, or other connectors or design, such as a flap, intended to secure the pocket's contents. The pockets 610 can be placed anywhere along the shoulder straps 602, and there can be any number of pockets 610 added to the shoulder straps 602 given space considerations. In one embodiment, a pocket may be used to carry a global positioning system (“GPS”) device that would allow the pack 100 to be tracked or located through the use of GPS. It should be appreciated that a GPS device or microchip may also be sewn into the shoulder strap to effect a more permanent placement.

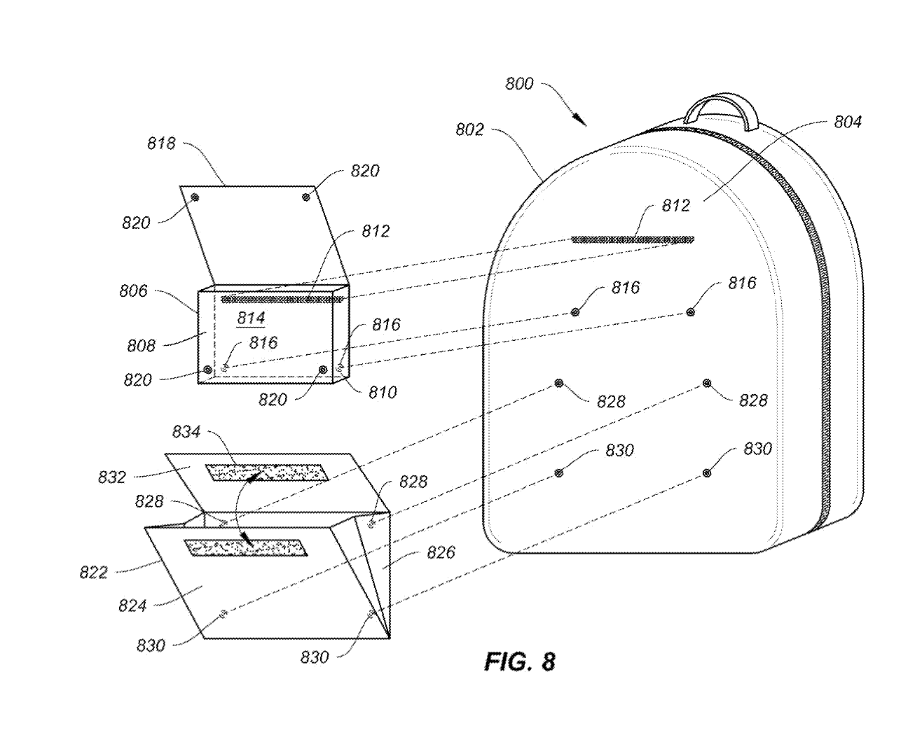

FIG. 7 is a rear view of the pack of FIG. 1 made according to another embodiment of the invention. In this embodiment, the back portion 104 is designed to accommodate an optional pull handle 702 and a pair of wheels 704 so that the pack 100 can be pulled or pushed by the user. In one embodiment, the pull handle 702 comprises two columns 703 that are attached to the backpack and that can be extended and retracted in a telescoping manner to allow a user, in an extended position, to hold the top of the pull handle 702 in a comfortable position and pull or push the pack. It should be appreciated that the pull handle 702 can be integrated into the back portion 104 of the pack. For example, the pull handle 702 can be attached to the inside of the back portion 104 of the pack as shown in FIG. 7, either permanently or removably by any means known in the art, and covered with a piece of material or plastic to separate the pull handle 702 from the inside of the pack. Alternatively, the pull handle 702 can be permanently or removably attached to the outside of the back portion 104 by any means known in the art. As noted attachment of the pull handle can be done by any means known in the art, including, for example, rivets that attached a portion of the pull handle to the back portion 104 of the pack or loops of material attached to the pack having, for example, hooks and loops that can be looped around a portion of the pull handle 702 to secure it to the pack. The wheels 704 can be permanently or removably attached to the bottom corners of the back portion 104 of the pack by any means known in the art. Further, additional wheels, including, for example, a second pair of wheels, may be used and attached, permanently or removably, to the pack at any other location, such as the front bottom corners of the pack. It should be appreciated that shoulder straps such as those described in connection with FIG. 6 may also be included on the pack along with the pull handle and wheels.

FIG. 7A is a side view of a pull cart according to one embodiment of the invention. The pull cart 750 includes a base 752 that has a vertical portion 754 and a horizontal bottom portion 756. The pull cart 750 also includes wheels 757 that are attached to the base 752. The pull cart 750 includes a pull handle 758 that can be extended and retracted from the vertical portion 754 of the base 752. An optional extension 758 can be used in connection with the horizontal bottom portion 756 to accommodate larger packs or packs that utilize the optional middle portion, described further below, to increase the size of the pack. The extension 758 can be extended and refracted from the horizontal bottom portion 756 and can include locking pins 760 to lock the extension 758 in a retracted position and in an extended position, the latter extended position being shown in FIG. 7A. The extension 758 includes feet 762 that can be used to support the pull cart 750 when not being pulled. As noted, the extension 758 is optional and can be removed from the pull cart 700. The pull cart 750 can be made from any material known in the art, including, for example, plastic or metal.

FIG. 7B is a perspective view of the pull cart of FIG. 7A. The pull cart 750 may also include brackets 764 to increase the stability and strength of the base 752, including both the vertical portion 754 and the horizontal bottom portion 756.

Referring back to FIG. 7A, the pack 766 can be attached to the pull cart in various ways. For example, the pull cart 750 can be integrated into the back portion of the pack. For example, the vertical portion 754 can be attached, permanently or removably, to the inside of the back portion of the pack and covered with a piece of material or plastic to separate the vertical portion 754 inside the pack from the rest of the inside of the pack. In this case, the pull handle 758 would extend through the top of the pack and the bottom of the vertical portion 758 would extend through the bottom of the pack. Alternatively, the pull cart 750 can be permanently or removably attached to the outside of the pack, including attachment of the back portion of the pack to the vertical portion 754 or attachment of the bottom of the pack to the horizontal bottom portion 756 or both. In either case, the attachment can be done by any means known in the art, including, for example, rivets that attached a portion of the vertical portion 754 or the horizontal bottom portion 756 to the pack or loops of material attached to the pack having, for example, hooks and loops that can be looped around the vertical portion 754 or the horizontal bottom portion 756 to secure those portions to the pack. It should be appreciated that depending upon the size of the pack, the extension 758 may need to be used in its extended position to support the pack, and the bottom of the pack can optionally be attached to the extension 758 by any means known in the art, including the examples described for attaching the pack to the vertical portion 754 and the horizontal bottom portion 756.

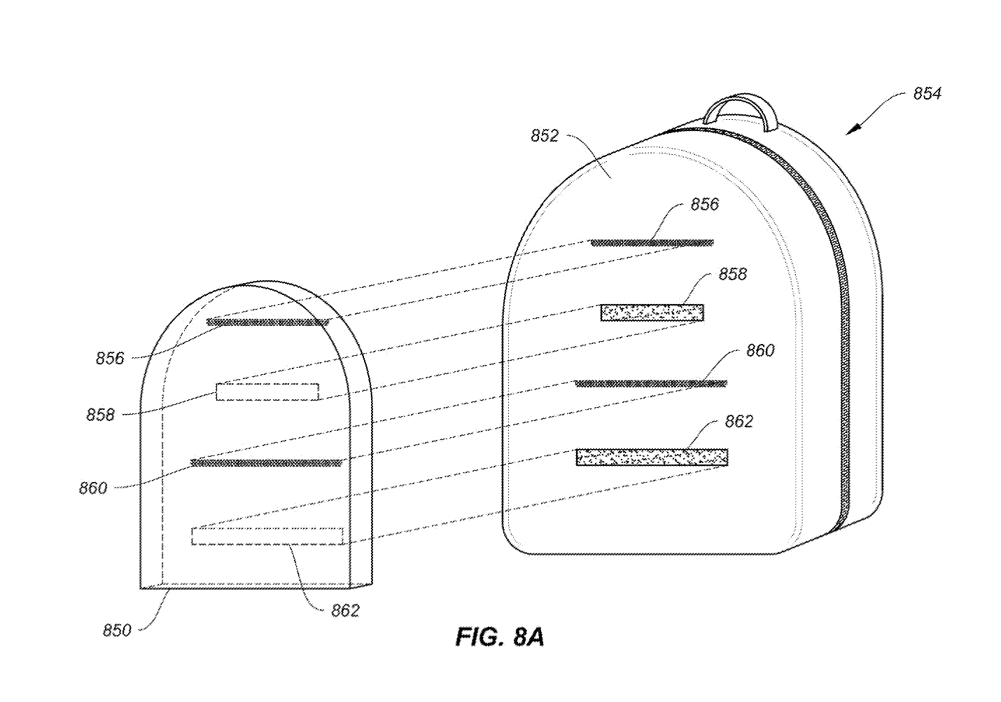

FIG. 8 is an exploded view of two pockets or compartments attached to a pack made according to an embodiment of the invention. As shown, the pack 800 has a front portion 802 comprising a front outer surface 804. The pockets illustrated in this FIG. 8 are exemplary of some of the various configurations that can be used for each pocket, including the shape and size, the manner in which the pocket is attached to the pack, and the manner in which any cover for the pocket is designed to open and close. It should be appreciated that while the pockets are described in the context of a front outer surface, varied and multiple pockets can be placed anywhere on the pack, including the back outer surface, the sides, the top, and the bottom, depending upon the desired end use of the pack and the user's preferences. In addition, while the pockets shown in FIG. 8 illustrate the use of a pocket cover to secure the contents of the pocket, it should be appreciated that a pocket cover could be used that does not attach to any other part of the pocket or pack and is simply, for example, a loose fitting or tight fitting cover or flap that drapes over the pocket opening or that tucks inside of the pocket. Further, it should be appreciated that a pocket may not have a cover but instead may use a connector to open and close the opening of the pocket, in which case, any connector, such as a zipper, hooks and loops, snaps, and buttons, may be used. In addition, it should be appreciated that pockets without covers can also be used.

The pocket 806 shown at the top of the pack 800 is rectangular in shape, both from its front side 808 and side 810. However, it should be appreciated that any pocket may have any shape from either the front or side perspective, including, without limitation, square, triangular, circular, oval, or any other geometric shape, as well as irregular shapes and including any combination of shapes, such as rectangular sides and a square front and back. Further, the size and volume of the pocket can be any size or volume.

The pocket 806 shown at the top of the pack 800 is attached to the pack 800 by a zipper 812, wherein one portion of the zipper is located on the pack 800 and the corresponding portion of the zipper 812 is located on the back side 814 of the pocket 806. Since the zipper 812 on the back side 814 of the pocket 806 is located slightly below the top of the pocket 806, when the pocket 806 is attached to the pack 800, the zipper 812 is hidden from view. Optionally, the bottom of the pocket 806 may also be attached to the pack 800. As shown, a pair of snaps 816 may be used to attach the bottom of the pocket 806 to the pack 800. However, it should be appreciated that a pocket may be attached to the pack using any means known in the art, including any of the connectors described herein such as zippers; snaps; buttons; eyelets on one portion of the pack and a corresponding series of connectors on the other portion, such as hooks, clasps, safety pins, and laces; and hooks and loops (e.g., VELCRO); buckles, snap hooks, swivel hooks, sliders, and webbing. For example, the same connectors used to connect the front portion and the back portion of the pack as described above in connection with FIGS. 1-5 may be used to connect a pocket to the pack. Also, it should be appreciated that the connectors used to attach the pocket to the pack may be used in a continuous manner about a perimeter of the pocket or in predetermined discrete and separate locations around the back side 814 of the pocket. Also, it should be appreciated that any portion or any side of the pocket can be attached to the pack. For example, instead of attaching the top edge or portion of a pocket to the pack and the corners, the middle of the back side or back surface of the pocket can be used as the location where the pocket is attached to the pack.

The pocket 806 also has a cover 818 that is used to cover the top opening of the pocket 806 to secure any contents placed in the pocket 806. As shown, the cover 818 is secured to the bottom of the front of the pocket 806 by a pair of snaps 820. It should be appreciated that any means known in the art may be used to secure the cover 818 to the body of the pocket 806, including any of the connectors described previously, which may include continuous or discrete and separate connectors. Also, the size of the cover 818 may be varied such that it covers only the opening of the pocket and does not extend to the bottom of the front of the pocket but rather extends a varied amount over the front of the pocket.

The pocket 822 shown at the bottom of the pack 800 has a square front side 824 and triangular sides 826 that can be folded in an accordion style. In this embodiment, the pocket 822 is attached to the pack 800 using two pairs of snaps 828, 830. A cover 832 is used to cover the opening of the pocket 822 and is secured to the front side 824 using a strip of hooks and loops 834.

As noted above, it should be appreciated that any number of pockets can be used and attached to the pack at any location. The pockets used can be any size or shape and have any desired interior volume. The pockets can be attached to the pack in any manner, including attachment to the pack in one or more locations on the pocket and respectively on the pack. Also, different types of connectors may be used to secure different areas of a pocket to the pack. Further, such connectors may be placed in any orientation on both the pack and the pocket to be secured to the pack. For example, snaps may be used at each corner of the pocket with corresponding snaps on the pack to secure the pocket to the pack. Alternatively, hooks and loops may be used anywhere on the back surface of the pocket, including the outside perimeter of the back surface, along the bottom perimeter of the back surface of the pocket, along one or both side perimeters of the back surface of the pocket, or diagonally on the back surface of the pocket, or in any combination of the foregoing. Also, any combination of connectors may be used to secure a pocket to the pack such as snaps at the corners and a set or sets of hooks and loops along disposed anywhere on the back surface of the pocket, including the outside perimeter of the back surface, along the bottom perimeter of the back surface of the pocket, along one or both side perimeters of the back surface of the pocket, or diagonally on the back surface of the pocket, or in any combination of the foregoing. It should also be appreciated that any number of connectors may be used to attach a single pocket to the pack.

Also, each pocket may optionally use a cover that can also be closed and secured to the pocket using any type of connector. Further, although the pockets 806, 822 shown in FIG. 8 are oriented such that their openings are at the top, it should be appreciated that pockets can be oriented such that their opening is facing in any direction, including to the side or downward. Further, any of the pockets may be further designed using different materials as described below and may include additional openings, with or without covers, that may open into the same or different embedded pockets.

FIG. 8A is an exploded view of a single pocket attached to a pack made according to an embodiment of the invention. In this embodiment, a single pocket 850 is attached to the front portion 852 of a pack 854. The single pocket 850 may be any size or shape, including, as shown in FIG. 8A, a size that covers a significant portion of the front surface of the front portion 852. The single pocket 850 may also be shaped to be similar to the shape or outer perimeter of the front portion 852 of the pack 854. As with the other pockets described in connection with FIG. 8, the single pocket 850 may also have any length, width, or depth or any interior volume. The single pocket 850 may also have any type of opening or cover (not shown) to allow access to the interior of the single pocket 850.

Also, as described above, the single pocket 850 may be attached to the pack, including attachment to any outer or inner surface of the pack, by any means known in the art. In addition, the single pocket 850 may be attached to the pack 854 in more than one location on the pocket 850 and correspondingly on the pack 854. For example, with reference to FIG. 8A, the single pocket 850 is attached to the pack 854 using four connectors 856, 858, 860, 862. As with the pockets described in connection with FIG. 8, the single pocket 850 may be attached using any type of connectors, wherein one portion of the connector is located on the pocket and the corresponding portion of the connector is located on the pack. In this case, the single pocket 850 is connected to the pack 854 using two zippers 856, 860 and two other connectors 858, 862, such as snaps or hooks and loops. It should be appreciated, that these connectors may be positioned anywhere on the pocket 854 so that when connected to the pack the single pocket 850 may be positioned higher or lower on the pack 854 or more to one side or the other. It should also be appreciated that the multiple connectors 856, 858, 860, 862 used on the pack 854 to allow the single pocket 850 to attach to the pack 854 in more than one location, can be positioned to allow two smaller pockets to be attached to the same connectors 856, 858, 860, 862 on the pack 854, similar to those shown in connection with FIG. 8, and thereby replace the single pocket 850.

FIG. 8B is another pocket attached to a pack made according to an embodiment of the invention. In this embodiment, a single pocket 870, which may be similar to that shown in connection with FIG. 8A, is attached to the front portion 872 of a pack 874. Attachment of the single pocket 870 to the pack 874 may be accomplished in any manner known in the art, including those described previously in connection with FIGS. 8 and 8A. As described above for other pockets, the single pocket 870 may be any size or shape and may have any opening or cover for accessing the interior of the pocket 870, for example, a zipper 876 as shown in FIG. 8B. In addition, a second smaller pocket 878 is attached to the front surface 880 of the single pocket 870. Similarly, this second smaller pocket 878 may also be any size or shape and may have any type of opening or cover for accessing the interior of the pocket 878, for example, a zipper 882 as shown in FIG. 8B. It should be appreciated that this pocket-on-pocket embodiment may be attached to any outer or inner surface of a pack. Further, it should be appreciated that each of the pockets 870, 878 may have any length, width, or depth or any interior volume.

FIG. 8C is an exploded view of the pockets illustrated in FIG. 8B. As shown, the smaller pocket 878 is attached to the outer surface 880 of the single pocket 870 using zipper 884 and another connector 886, such as snaps or hooks and loops. It should be appreciated, as with other pockets, any type of connector may be used and one or more connectors may be used. It should also be appreciated that the smaller pocket 878 may be placed anywhere on the outer surface 880 of the single pocket 870. For example, the smaller pocket 878 may be strategically placed to cover the opening of the single pocket 870 or thereby to substitute for a cover for the single pocket 870. It should also be appreciated that the single pocket 870 can be used without having a smaller pocket attached, even though the single pocket 870 may still have connectors located the outer surface 880 of the single pocket 870 for later attachment of a smaller pocket.

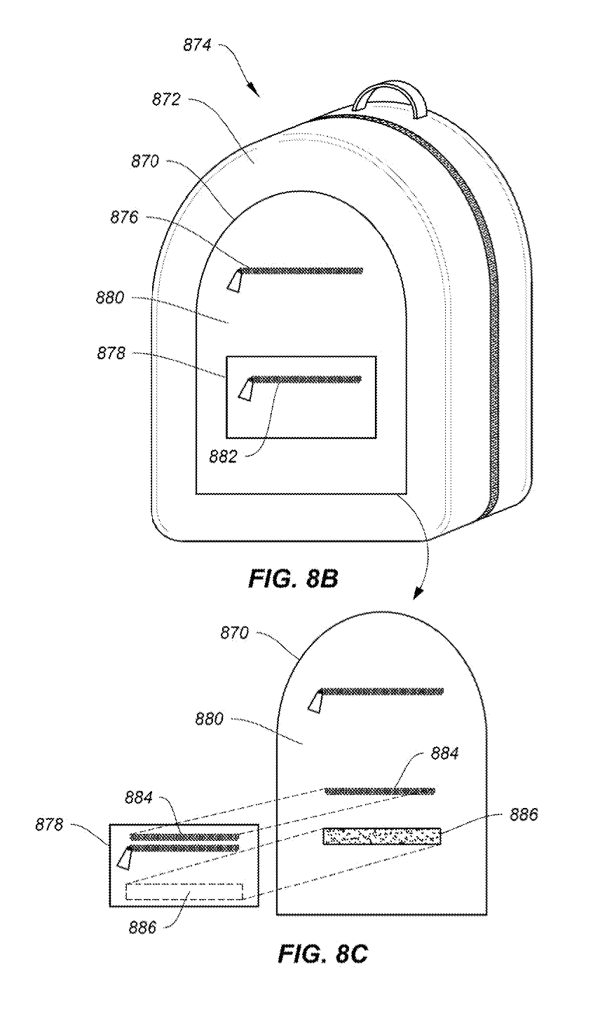

FIG. 9 illustrates a side pocket attached to a side of a pack according to an embodiment of the invention. The pack 900 has a side 902, a releasable connection 904, and a side pocket 906. One side of the pocket 906 is attached to a front portion 908 of the pack 900 using a zipper 910, although any connectors previously described may be used. The opposite side of the pocket 906 may be attached to a back portion 912 of the pack 900 using a pair of snaps 914 or any other connectors previously described. Accordingly, the pocket 906 is shown in an “open” position and when both sides of the pocket 906 are attached to the pack 900 (i.e., when one side of the pocket 906 is attached to the front portion 908 of the pack 906 and the opposite side of the pocket 906 is attached to the back portion 912 of the pack 906), the pocket is in a “closed” position. When in a closed position or fully secured to the pack 906, the side pocket 906 covers a portion of the releasable connection 904 and acts to further secure the front portion 908 to the back portion 912. It should be appreciated that a side pocket can be disposed anywhere along the side of the pack. Further, the side pocket may have any height and can be any shape as described above for other pockets.

Pockets, including any pockets used on any portion of the pack, including side pockets, can be sized and used for a variety of purposes, including any purpose identified by an end user. In other words, pockets can be specifically designed for an end user's identified purpose. Otherwise, pockets can be used generically to carry anything, including without limitation, pencils, pens, cell phones, make-up or cosmetics, food including hot or cold food (in which case the pocket can be made from a thermal insulating material or simply be designed to receive a thermal insulating material that conforms to the pocket interior or that provides a sufficient space to receive the hot or cold food and maintain its temperature), books, laptop computers and other electronic devices (in which case the pocket may be made from a more durable and padded material to protect against impact), clothes, toys, sports equipment including water bottles, bottled liquid, and diapers and other baby-related products. A pocket having separate compartments or pockets within it may also be used. A pocket for holding a gun, for example, a pistol for use by law enforcement, can be used. A pocket configured to receive solar energy and convert that energy to electrical energy for using, charging, or recharging an electronic device such as a computer, cell phone, portable media device (such as a DVD or music file player), electronic book reader, or computer tablet can be used. A pocket designed to receive and hold a GPS chip to allow tracking of the pack and the user of the pack can be used.

It should also be appreciated that in addition to pockets, other items can be attached to the pack using any connectors or methods of connection known in the art, including those described above. In other words, a user may attach any desired article to the pack provided it has a connector to form a connection with a corresponding connector on the pack. For example, rather than have a pocket attached to the pack for holding a water bottle, an existing cover for a water bottle can be retrofitted with a connector and then connected to a corresponding connector on the pack.

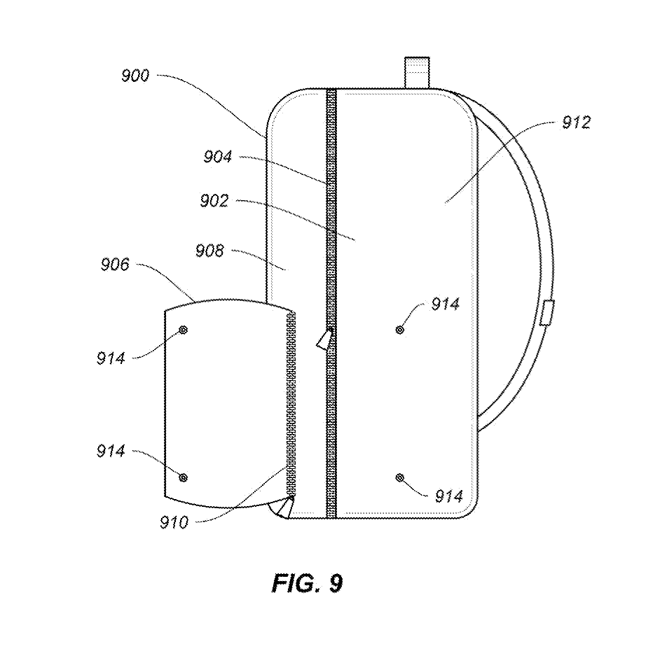

FIG. 10 is an exploded side view of a pack and a middle portion according to an embodiment of the invention. The pack 1000 has a front portion 1002 and a back portion 1004 that can be connected to each other by a releasable connection. As shown, the releasable connection is a connection that uses two cooperating connector parts 1006, 1008 that mate together to form the releasable connection. The pack 1000 also has a middle portion 1010 or expansion panel that is optionally disposed between the front portion 1002 and the back portion 1004 to expand the size of the accessible space that would otherwise be formed only by the connection of the front portion 1002 and the back portion 1004. In other words, by inserting the middle portion 1010 in between the front portion 1002 and the back portion 1004, the accessible space will be larger.

The middle portion 1010 also comprises a front connector portion on a first side and a back connector portion on a second side that allow the middle portion 1010 to be connected to the front portion 1002 and the back portion 1004, respectively. More specifically, the front and back connector portions of the middle portion 1010 are connected to the front portion 1002 and the back portion 1004, respectively, by using the same type of connectors 1012, 1014 used by the front portion 1002 and the back portion 1004. By using the same type of connectors that are used to form the releasable connection between the front portion 1002 and the back portion 1004, the middle portion 1010 can be easily inserted and removed, thereby expanding the pack 1000 as needed and returning it to a smaller size as needed by simply connecting the front portion 1002 directly to the back portion 1004.

It should be appreciated that any of the features described above for a pack can be added to the middle portion 1010. For example, a handle, similar to the handle 108 shown in FIG. 1, can be added to the middle portion 1010. In addition, a liner can be added to the middle portion in a manner similar to that described above. Further, any of the pockets described above can be added to the middle portion 1010, including a side pocket having one side that attaches to the middle portion 1010 and an opposite side that attached to either, or both, of the front portion 1002 and the back portion 1004. Further, a side pocket that attaches to the front portion 1002, extends over the middle portion 1010, and attaches on its other side to the back portion 1004 may be used.

Turning to other features of the pack, the back portion 104 may optionally provide bullet-proof protection, particularly in those instances when the pack will be carried using shoulder straps such that the back portion would hinder a projectile or bullet from passing through the back side and into the body of a person carrying the pack. In this case, the back side itself can be construed from a bullet-proof material such as KEVLAR. Alternatively, a sleeve can be attached to the back inner surface of the back portion of the pack into which a bullet-proof plate could be inserted and removed. In another embodiment, an optional pocket or sleeve, as described below, into which a bullet-proof plate could be inserted and removed, could be attached to the back outside surface of the back portion of the pack.

Also, in some embodiments, a liner can be added to the front and back portions to line the accessible space. In one embodiment, a separate liner that conforms to the size and shape of the accessible space can simply be inserted into the pack once the front and back portions are connected. Alternatively, a liner material could be permanently or removably attached to the inner surface of the front portion and the back portion, including the front and back inner surfaces, as well as the inner surfaces of any panels. The liner can be a plastic material that could be used to prevent moisture from the contents of the pack from contacting the material of the front portion and the back portion. The liner could also be an antimicrobial liner or a liner that has been treated with an antimicrobial material, such as AGION. It should be appreciated that if a liner is used, the liner is considered part of the front or back inner surfaces for purposes of defining the accessible space created by the front portion and the back portion. In other words, the accessible space is still considered to extend from the front inner surface to the back inner surface once the front and back portions are connected, even if a liner is used.

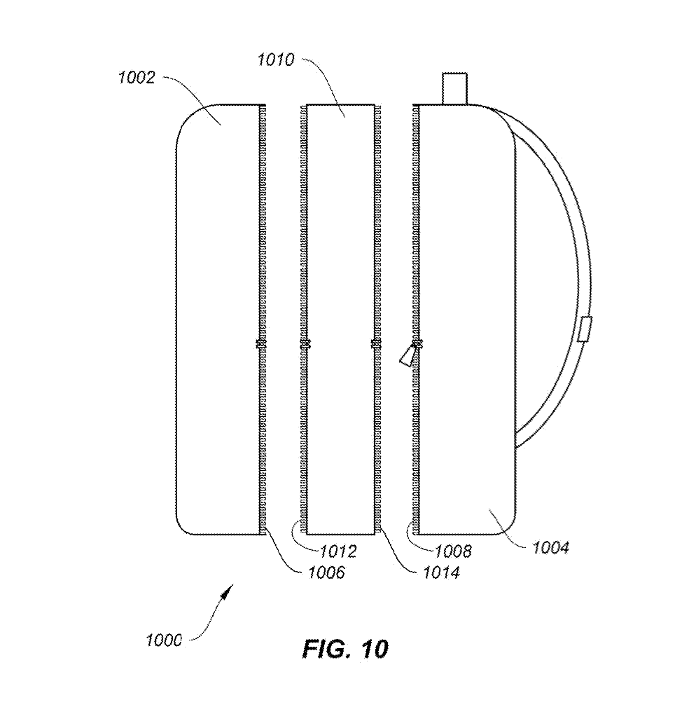

FIG. 11 is a partial perspective view of a releasable connection between a front portion and a back portion of a pack according to an embodiment of the invention. It should be appreciated that the front and back connection perimeters may be the same as the exterior perimeter or outermost edge of the respective front and back panels. In other embodiments, however, the front and back connection perimeters may be recessed from the outer most edge of the respective front and back panels. For example, the front connection perimeter may be a given distance away from the edge of the front panel so that upon connection with the back portion, that portion of the front panel that extends from the front connection perimeter to the front panel outer edge serves as a flap that covers the connection perimeter or the releasable connection itself. Similarly the back connection perimeter may be a given distance away from the edge of the back panel so that upon connection with the back portion, that portion of the front panel that extends from the front connection perimeter to the front panel outer edge serves as a flap that covers the connection perimeter or the releasable connection itself

As shown in FIG. 11, a front portion 1102 overlaps a back portion 1104, noting that this view is from the interior of a pack. A releasable connection 1106 is formed such that a flap 1108 of the front portion extends past the edge of the back portion 1110 used in forming the releasable connection 1106. In this manner, the releasable connection 1106 is both hidden and protected from the environment by the flap 1108. It should be appreciated that a flap can also be created by an overlapping back portion instead of a front portion. Further, it should be appreciated that a flap can also be used in connection with a middle portion or expansion panel, wherein the flap can be attached to the middle portion (e.g., where the middle portion overlaps the front or back portion) or vice versa. It should also be appreciated that a flap can be a separate piece of material that is attached to a given portion as opposed to being an integral part of that portion.

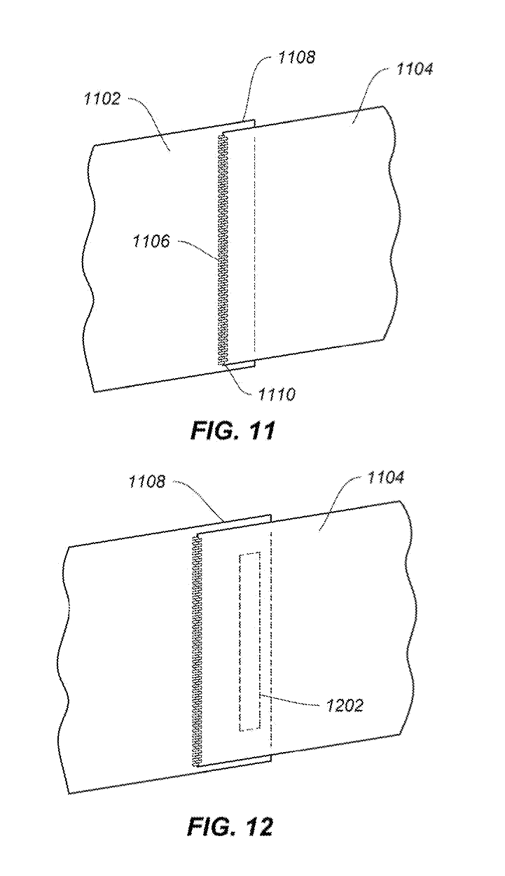

FIG. 12 is a perspective view of another releasable connection between a front portion and a back portion of a pack according to an embodiment of the invention. This FIG. 12 is similar to FIG. 11 with the exception that the flap 1108 is designed to be secured to the back portion 1104 using a connector, such as hooks and loops, although any connector may be used. It should be appreciated that the entirety of the flap may also be made of hooks and loops to further secure the connection between the front portion and the back portion, as well as any middle portion, of the pack.

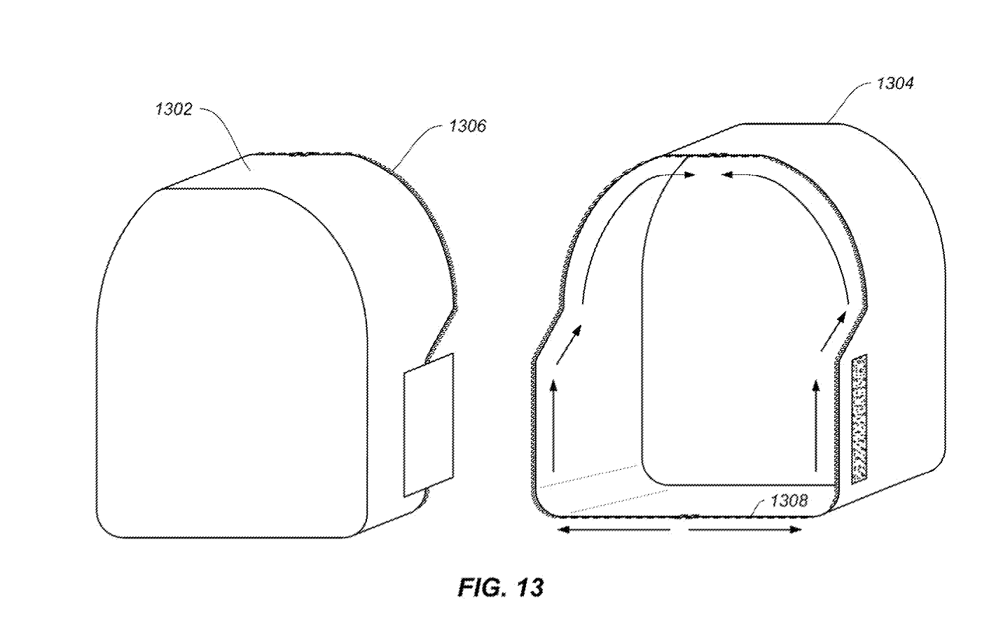

FIG. 13 is a perspective view of another pack according to an embodiment of the invention. A pack 1300 has a front portion 1302 and a back portion 1304. In this embodiment, the front and back connection perimeters 1306, 1308 extend about an outer edge of each of the front and back portions 1302, 1304 and are not in a single plane. Therefore, when the front and back portions 1302, 1304 are connected together, the releasable connection formed is similarly not in a single plane. Accordingly, it should be appreciated that the front and back portions of the pack may have any shape and the front and back connection perimeters may have any contour, including regular geometric contours, such as circles, ovals, squares, rectangles, triangles, etc., and irregular contours. In these cases, it should be appreciated that multiple connectors may be used or necessary to connect the front portion and the back portion to each other to provide a releasable connection. For example, with reference to FIG. 13, two or more zippers may be used or needed to allow the formation of the releasable connection given the contour of the front and back connection perimeters. Also, multiple sets of hooks and loops discretely placed along the front and back connection perimeters may also be used to effect the releasable connection in embodiments where the front and back connection perimeters have an irregular contour.

It should also be appreciated that depending upon the configuration of the front portion and the back portion and the location of the front connection perimeter and the back connection perimeter, the ultimately formed connection perimeter or the location of the releasable connection may be anywhere on the pack. As described above, the location of the front connection perimeter and the back connection perimeter may be anywhere on the front portion and the back portion, respectively. Accordingly, it should be appreciated that the location of the releasable connection or the connection perimeter may also be anywhere on the pack. Further, it should be appreciated that a middle portion or expandable panel can also be used in conjunction with a front portion and back portion in which the respective front and back connection perimeters are not in a single plane. In this case, the middle portion would simply conform to the shape of the front and back portions.

It should be appreciated that any part of the pack described above, including the front portion and the back portion of the pack, as well as any pockets and middle portions or expandable panels, may be made from any material, such as any type of cloth, leather, or plastics and polymers. For example, these parts may be made from, without limitation, cordura; duck and canvas; leather and leatherette; nylon; denier nylon; taffeta; urethane coated nylon; neoprene; eco-friendly fabrics such as organic or natural materials including bamboo, cotton, linen, soybean, and hemp; rip stock; laminated or coated fabrics; cotton; vinyl (expanded, clear, etc.); regency; polyester and denier polyester; polypropylene such as super strong woven polypropylene; knit materials; rip stop; solar materials that incorporate solar cells capable of receiving solar energy and supplying power to an electrical device, for example, small personal devices such as cell phones, computers, PDAs, netbooks, laptops, ebook readers, computer tablets, etc. and may consist of a lightweight tensile fabric with integrated thin film solar panels or cells; KEVLAR and ballistic nylon; fleece; flannel; insulated plastic and insulated vinyl; batting; muslin; Tahoe multi-ply taslan; netting; mesh; plastic; textured fabric such as fake fur and corduroy; waterproof TEFLON; waterproof satin; microfiber easy-maintenance fabric; and poly canvas with water-resistant finish. Materials that can be used include fabric and other materials that are washable to enable cleaning of the pack. In addition, the materials may be pre-treated with water proofing materials. It should be appreciated that the front portion and the back portion may each be made from a combination of any of these materials and may each be made from different materials or different combinations of materials. Further, these materials may be made and used with any design, such as different colors and patterns, as well as designs to make the pack resemble something such as an animal.

The packs made according to the embodiments described above may also include additional design elements or features. For example, many different design items may be attached to any part of the pack. For example, reflector tape, embroidery, stick-ons, beading, and clip-on toys may all be included. Also, the material used to make the pack may be printed with ink to produce various designs and colors, including, for example, optical illusions. In addition, sound devices or devices that make sounds when squeezed may be imbedded in the material of the pack or in a pocket. Further, the pack can be designed to resemble an animal by adding animal parts to the pack, such as a pony tail, blinking eyes, a ducks beak, or an elephant nose and the like or to resemble some other figure, such as a ballerina wherein the pack may have a frilly skirt attached to it.

It should also be appreciated that the pack and various features, such as pocket and other components, including all of those described above, may be in the form of a system that allows the pack to be constructed and customized and subsequently customized in a different manner. In other words, multiple variations of each of the parts or components of the pack can be pre-made to offer a user a selection and the ability to customize the pack by separately selecting each of the parts of the pack and combining them to form a customized pack. In this case, the user can then later replace a given part of the part with another pre-made part that can be substituted or that is compatible with the remaining part of the pack. All of these pre-made components of the pack system can be offered in a physical retail space, by mail, or online through an ecommerce store.

For example, the front portion and the back portion may each be separately selected from a plurality of pre-made front portions and back portions provided that the front portion and the back portion, or their respective connector portions and connectors are compatible and can be connected to each other to form the pack. These pre-made portions may be made from different materials with different designs. This allows the user to switch or interchange front and back portions and to utilize other compatible front and back portions with an existing front or back portion to further customize the pack. In other words, the user can construct one pack using a first set of front and back portions and later elect to use a different front portion with the existing back portion or vice versa.

Further, various optional middle portions can also be pre-made in various sizes and materials. Middle portions can be pre-made to offer middle portions that have a range of widths to allow the pack to be expanded only a nominal amount to a larger amount, such that the accessible space may be increased by 25%, 50%, 75%, 100% or even more. Further, the user may select multiple pre-made middle portions for use to allow the user to switch middle portions for an existing pack.

Further, the front, back, and middle portions can each be pre-made with various other features, such as liners, pockets on the inside and outside, and the addition of a pull handle or cart. Further, the front, back, and middle portions may simply include one side of a cooperating connector placed in a pre-determined location, which allows the user to customize each of the front, back, and middle portions by separately selecting pockets or compartments to be attached with a corresponding cooperating connector. For example, the front, back, and middle portions can be constructed with a strip of hooks located at one or more various pre-selected locations, including inside and outside of the portions. The user can then select various pockets or compartments with corresponding strips of loops to attach to those specific locations on the front portion and the back portion. This also allows the user to easily add, change, or switch the pockets or compartments that are attached to the pack to further customize the pack. In other words, the placement of connectors on both portions of the pack and pockets, or other attachments, can be standardized so that each pocket can be interchanged with another pocket on a given portion of the pack. For example, the length of a connector can be standardized or made the same on both the pack and pockets so enable the same connection between the pack and each type of pocket. Further, a pair of connectors can be used on all of the various attachments that can be added to the pack, such as pockets, where the connectors are a predetermined distance apart from each other on both a given surface of the pack and on the pockets so that pockets can be interchanged and both connectors on the a given pocket will mate with the corresponding connectors on the pack.

Various embodiments of the invention have been described above. However, it should be appreciated that alternative embodiments are possible and that the invention is not limited to the specific embodiments described above. For example, the size, shape, appearance, including the addition of pockets can be varied according to a user's desires and needs. It should also be appreciated that a pack can be construed only with strips of hooks and loops, or one part of a two connector system (e.g., a button hole or one-half of a zipper), on its outer surface as a place where an optional pocket may be added if desired. In other words, the pack does not have to include pockets but can be configured as ready to have pockets attached. In addition, although several of the releasable connections have been described as zippers or hooks and loops, it should be appreciated that any of the connectors described herein may be used, as well as other connectors known in the art. Also, since the pack and all of its various features as described above are customizable, the pack can be viewed as a system having various component parts from which a pack is constructed. Accordingly, the description of these embodiments should be considered exemplary of various embodiments that fall within the scope of the present invention as defined by the claims.

What is claimed is:

1. A pack, comprising:
a front portion comprising a front inner surface of a pack and a front connection perimeter; and
a back portion comprising a back inner surface of said pack and a back connection perimeter;
wherein said front portion and said back portion are configured to be connected by a releasable connection disposed along a connection perimeter formed by alignment of said front connection perimeter and said back connection perimeter and to define an accessible enclosed space of said pack that extends from said front inner surface to said back inner surface.

2. The pack of claim 1, wherein said accessible enclosed space is a main compartment of a backpack.

3. The pack of claim 1, wherein said front portion further comprises a front panel that extends about a perimeter of, and away from, said front inner surface and said front connection perimeter extends about a perimeter of said front panel; and wherein said back portion further comprises a back panel that extends about a perimeter of, and away from, said back inner surface and said back connection perimeter extends about a perimeter of said back panel.

4. The pack of claim 3, wherein said releasable connection is formed between said front panel and said back panel.

5. The pack of claim 3, wherein said front panel comprises a front panel edge that extends about said perimeter of said front panel and said back panel comprises a back panel edge that extends about said perimeter of said back panel, and wherein said releasable connection is formed between said front panel edge and said back panel edge.

6. The pack of claim 1, wherein said releasable connection comprises a first connector portion disposed on said front portion along said front connection perimeter and a second connector portion disposed on said back portion along said back connection perimeter, and wherein said first connector portion and said second connector portion cooperate to form said releasable connection.

7. The pack of claim 1, wherein said releasable connection extends continuously about said connection perimeter.

8. The pack of claim 7, wherein said releasable connection comprises a zipper.

9. The pack of claim 7, wherein said releasable connection comprises a hook and loop fastener.

10. The pack of claim 1, wherein said releasable connection comprises a plurality of discrete sections of hook and loop fasteners disposed about said connection perimeter.

11. The pack of claim 1, wherein said front portion comprises a flat front outer surface in a first plane and said back portion comprises a flat back outer surface in a second plane parallel to said first plane, and wherein said releasable connection is formed in a third plane between and parallel to said first and said second planes.

12. The pack of claim 1, further comprising at least one connector portion disposed on said pack and configured to releasably connect to a cooperating connector portion disposed on a separate compartment.

13. The pack of claim 12, further comprising at least one separate compartment releasably connected to said pack.

14. The pack of claim 1, further comprising a middle portion disposed between, and releasably connected to, said front portion and said back portion, thereby increasing a volume of said accessible enclosed space.

15. The pack of claim 1, further comprising a pull handle and a pair of wheels.

16. A pack, comprising:
a front portion comprising a front surface of a pack and a front connector portion disposed about a perimeter of said front portion; and
a back portion comprising a back surface of said pack and a back connector portion disposed about a perimeter of said back portion;
wherein said front portion and said back portion are configured to be connected by a releasable connection formed between said front connector portion and said back connector portion to define an accessible enclosed space of said pack that extends from said front surface to said back surface.

17. The pack of claim 16, further comprising a middle portion disposed between, and releasably connected to, said front portion and said back portion, thereby increasing a volume of said accessible enclosed space.

18. The pack of claim 16, further comprising at least one separate compartment releasably connected to said pack.

19. A system for a pack, comprising:
a front portion selected from a plurality of front portions, each comprising a front connector portion and constructed from a front material selected from a plurality of materials;
a back portion selected from a plurality of back portions, each comprising a back connector portion compatible with said front connector portion to allow a releasable connection to be formed by connecting the front connector portion and the back connector portion, and each constructed from a back material selected from said plurality of materials; and
at least one pocket configured to be attached to either said front portion or said back portion selected from a plurality of pockets each configured for attachment to either said front portion or said back portion.

20. The system of claim 19, further comprising a middle portion selected from a plurality of middle portions, each having a first side configured to form a releasable connection with said front connector portion of said front portion and a second side configured to form a releasable connection with said back connector portion of said back portion to thereby increase a volume of said accessible enclosed space, and each constructed from a middle material selected from said plurality of materials.
